(19) United States
(12) Patent Application Publication
(10) Pub. No.: US 2007/0271438 A1
(43) Pub. Date: Nov. 22, 2007

(54) APPARATUS AND METHOD FOR PARTITIONING HARD DISK WITHOUT REBOOT

(75) Inventors: Won-chang LEE, Suwon-si (KR); Keon-young CHO, Yongin-si (KR); Dai-young SHIN, Yongin-si (KR); Min-hyung LEE, Anyang-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/677,333

(22) Filed: Feb. 21, 2007

(30) Foreign Application Priority Data
May 17, 2006 (KR) 2006-44414

(51) Int. Cl. G06F 12/06

(52) U.S. Cl. 711/173

(57) ABSTRACT

An apparatus and method for partitioning a hard disk drive (HDD), more particularly an apparatus and method for partitioning the HDD into a desired number of partitions of a desired size without requiring a reboot once user registration has been completed. The apparatus includes an input unit that receives user registration and partition configuration information, a state-check unit that checks the state of a master partition, a hidden-partition-checking unit that checks the number of hidden partitions in order to determine whether the execution of partition is achievable if the result of the check shows that the master partition is in in-progress state, and a partition-execution unit that executes partitioning a slave partition based on the input partition-configuration information if the result of the check shows that execution of the partition is achievable.

### CROSS-REFERENCE TO RELATED APPLICATION

This application claims the benefit of Korean Application No. 2006-44414, filed May 17, 2006 in the Korean Intellectual Property Office, the disclosure of which is incorporated herein by reference.

### BACKGROUND OF THE INVENTION

1. Field of the Invention

Aspects of the present invention relate to an apparatus and method for partitioning a hard disk drive (HDD) and, more particularly, to an apparatus and method for partitioning the HDD into a desired number of partitions of a desired size without requiring a reboot once user registration has been completed.

2. Description of the Related Art

Generally, when a user purchases a computer, it comes with hardware and installed software that operates on the hardware. The software includes an operating system (OS), device drivers, application programs, and network software. In addition, due to the introduction of large-capacity HDDs and the concept of partitioning, partitioning a HDD into two or more partitions has become popular among users. For example, a user can install the OS and utilities on a primary partition and store data in an extended partition, thereby increasing the performance of the PC and making data storage more convenient.

However, conventional partition-related programs require multiple reboots and significant amounts of time and thus are inconvenient. In addition, some PCs have a factory default number of partitions (e.g., two). Hence, if the user wishes to change the number of the partitions or to have a single storage space on the HDD as opposed to two, the user must erase the partitions, format the HDD, and re-install the OS and other applications.

U.S. Pat. No. 6,526,493 (Method and Apparatus for Partitioning and Formatting a Storage Medium Without Rebooting by Creating a Logical Device Control Block On-the-fly) discloses a method of identifying partitions that have not been previously formatted, associating the created logical device control blocks with physical device control block information of the identified partitions, assigning drive letters to the identified partitions, and associating the drive letters with the physical device control block information. The drive preparation is configured to be performed without having to reboot the computer system driving the preparation after the partitioning or after the formatting. However, the method does not disclose a technique for having an unassigned drive on a HDD so a user can assign the drive and increase the size thereof.

### SUMMARY OF THE INVENTION

Aspects of the present invention allow a user to divide a HDD into a desired number of partitions having a desired size without requiring a reboot after the completion of user registration when an apparatus is booted.

Additional aspects and/or advantages of the invention will be set forth in part in the description which follows and, in part, will be obvious from the description, or may be learned by practice of the invention.

According to an aspect of the present invention, there is provided an apparatus to partition a HDD including an input unit to receive user registration and partition configuration information; a state-check unit to check the state of a master partition; a hidden-partition-checking unit to check the number of hidden partitions in order to determine whether partitioning is achievable if the state-check unit determines that the master partition is in an in-progress state; and a partition-execution unit to partition a slave partition based on the input partition-configuration information if the hidden partition checking unit determines that partition is achievable.

According to another aspect of the present invention, there is provided a method of partitioning a HDD including checking the state of a master partition; checking the number of hidden partitions in order to determine whether the execution of a partition is achievable if the checked state of the master partition is an in-progress state; partitioning a slave partition based on the input partition-configuration information if the checked number of hidden partitions shows that partitioning is achievable; and formatting the partition after partitioning is complete.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a configuration of a HDD built in an apparatus for partitioning the HDD without requiring a reboot according to an embodiment of the present invention;

FIG. 2 is a block diagram of an apparatus for partitioning a HDD without requiring a reboot according to an embodiment of the present invention;

FIG. 3 illustrates a partition-configuration screen displaying partition information received in an apparatus for partitioning a HDD without requiring a reboot according to an embodiment of the present invention;

FIG. 4 is a flow chart illustrating an apparatus for partitioning a HDD without requiring a reboot according to an embodiment of the present invention;

FIG. 5 illustrates a process of partitioning a HDD in an apparatus for partitioning the HDD according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

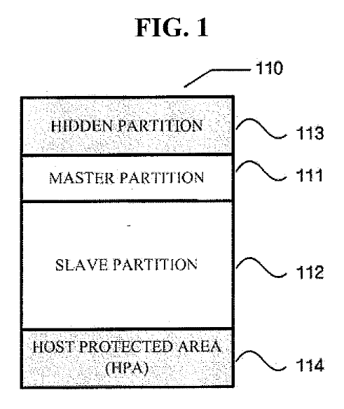

FIG. 1 illustrates a configuration of a HDD built in an apparatus for partitioning the HDD without requiring a reboot according to an exemplary embodiment of the present invention. The apparatus refers to desktops, laptops, personal digital assistants (PDAs), storage devices, media players, and other computing devices. Some aspects of the present invention have two or more HDDs. One of the selected HDDs (hereinafter referred to as a “first HDD”) has a configuration as illustrated in FIG. 1. A first HDD 110 is divided into an accessible partition and an inaccessible partition.

The accessible partition is further divided into a master partition 111, where an OS may be stored, and a slave partition 112, where software and a predetermined data file may be stored. The master partition 111 may be created as a minimal size partition when a master disk is created and may be understood as partition C. The creation of the master disk refers to a process of installing an OS in the master partition 111. The master partition 111 may be augmented according to the size of the slave partition 112. Any data may be stored in the master partition 111 and the slave partition 112.

According to another embodiment of the invention, the slave partition 112 may not be allocated in the first HDD 110, in order to augment the master partition 111 or to be partitioned later. The slave partition 112 may be divided into a predetermined number of partitions according to user configuration or may augment the master partition 111. A reboot is not required when the maximum space on the HDD 110 is saved for the non-allocated slave partition 112 prior to partitioning the HDD 110.

File information is not displayed in an explorer window in the inaccessible partition so that the user cannot access it. As a result, it is difficult for the user to make any modifications to the inaccessible partition. The inaccessible partition can be further divided into a hidden partition 113 storing fingerprint-detection information and XPE MIO and a host protected area (HPA) 114 used for specific applications. Data included in the hidden partition 113 and the HPA 114 may include other data and may further include any number of hidden partitions. In addition, the HPA 114 is reserved regardless of OS and may be used by an application that automatically backs up and protects the OS, other applications, and data. The HPA 114 can be, for example, a static restore partition.

The hidden partition 113 and the HPA 114 may be recognized as a primary partition. The slave partition 112 may also be recognized as the primary partition. In a commonly used OS, a total of four partitions are available. For that OS, if there are four primary partitions already in the first HDD 110, the slave partition 112 may be indivisible. Other operating systems may have a different maximum number of partitions.

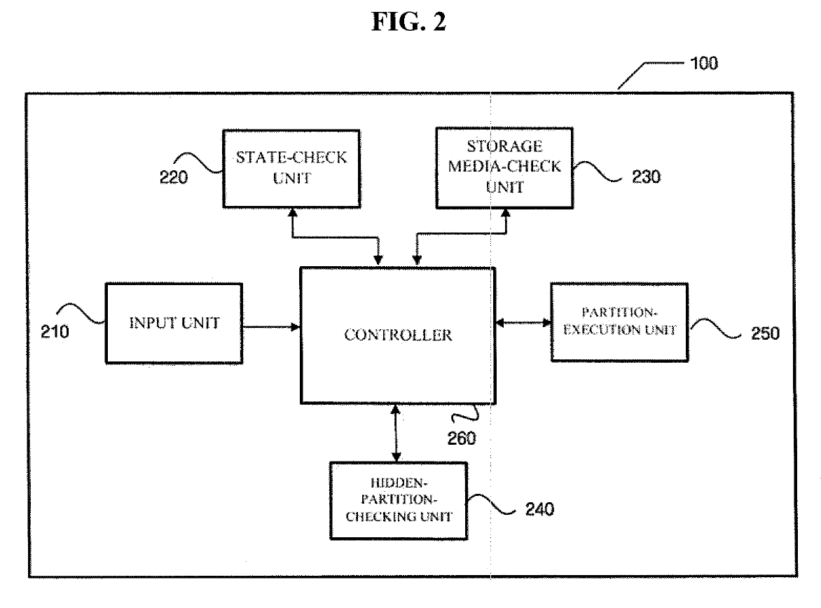

FIG. 2 is a block diagram of a partitioner 100, which is an apparatus to partition a HDD without requiring a reboot according to an embodiment of the present invention. The partitioner 100 includes an input unit 210, a state-check unit 220, a storage-medium-checking unit 230, a hidden-partition-checking unit 240, a partition-execution unit 250, and a controller 260.

While not required, one or more of the input unit 210, the state check unit 220, the storage medium checking unit 230, the hidden partition checking unit 240, the partition execution unit 250, and the controller 260 can be implemented in one or more modules. The term “module” includes, but is not limited to, a software or hardware component, such as a Field Programmable Gate Array (FPGA) or an Application Specific Integrated Circuit (ASIC), which executes certain tasks. A module may advantageously be configured to reside in the addressable storage medium, and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The input unit 210 receives generated input signals, such as from a user. The generated input signals refer to signals generated when user-registration information and partition-configuration information is input by the user. However, it is understood that the input signals could be otherwise generated.

The state-check unit 220 checks the state of the master partition 111. The state may be classified into a stand-by state, where the master partition 111 has not been booted yet, and an in-progress state, where user registration has been completed since an initial boot. In this case, a point of time at which partition is executed is determined based on the state of the master partition 111.

The storage-medium-checking unit 230 checks the number of available storage media (e.g. a second HDD, a CD-ROM, and other removable storage medium), which is performed in order to reassign drive letters for user convenience once the partition has been executed.

The hidden-partition-checking unit 240 checks the number of hidden partitions (e.g. the hidden partition 113 and the HPA 114) in the first HDD 110 in order to check whether the partition can be executed when the master partition 111 is in the in-progress state. An OS may have a maximum number of partitions (such as four) and each hidden partition may be recognized as a primary partition. Accordingly, the checking of the hidden partitions is performed in order to determine whether the slave partition 112 can be divided. If the first HDD 110 has been already divided into four primary partitions or if it has been divided into three primary partitions but there is a possibility that an additional partition will be created due to some programs installed on a system, the slave partition 112 may be indivisible.

The partition-execution unit 250 executes the partition of the slave partition 112 based on partition-configuration information (e.g. the number of partitions and the size thereof input by the user. In addition, the partition-execution unit 250 reassigns the drive letters order as follows (although other orders are possible). The order of the storage medium (excluding the master partition 111) is the HDD (e.g., the slave partition 112 of the first HDD 110 and the second HDD), the CD-ROM, and other removable storage media.

For example, assuming that the accessible partition is 50 Gb and the master partition 111 is 10 Gb, if the user divides the accessible partition into two partitions through the partition-configuration screen and specifies a size of 30 Gb for the newly divided partitions, the partition-execution unit 250 divides the partition of the slave partition 112 according to the user configuration. The user-configured partition 30 Gb is subtracted from the overall size of the slave partition 112 (e.g. 40 Gb) and is added to the master partition 111. As a result, the master partition 111 is increased to 20 Gb. The accessible partition is divided into the master partition (e.g. 20 Gb) and the slave partition (e.g. 30 Gb).

The partition-execution unit 250 initializes all drive letters, except for the master partition 111 (i.e., partition C), and reassigns the drive letter order based on the newly divided partitions. For example, the slave partition 112 may be set to partition D.

The controller 260 formats the newly divided partitions in the form of a random file. The controller 260 controls the operation of the input unit 210, the state-checking unit 220, the storage medium checking unit 230, the hidden-partition checking unit 240, and the partition-execution unit 250.

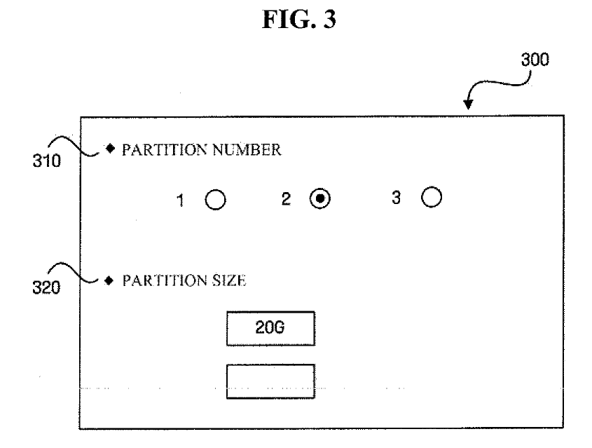

FIG. 3 illustrates a partition-configuration screen displaying partition information in an apparatus for partitioning a HDD without requiring a reboot according to an embodiment of the present invention. A user can specify the number and size of partitions through a partition-configuration screen 300. If the user wishes to set up a first HDD 110 as a single partition, the user selects “1” in PARTITION NUMBER 310 on the partition-configuration screen 300. Accordingly, the slave partition 112 is combined with the master partition 111, leaving only the partition 111 in the first HDD 110. Since the slave partition 112 is combined with the master partition 112, the user need not specify the partition size.

Conversely, if the user wishes to set up the first HDD 110 as two partitions, the user selects “2” in PARTITION NUMBER 310 on the partition-configuration screen 300 and specifies a partition size (e.g. 20 G) in PARTITION SIZE 320. A part of the slave partition 112 is then divided into a desired number in a desired size (e.g., 20 G), which is set by the user, and the rest of the slave partition 112 is combined with the master partition 111. Accordingly, two partitions, the master partition 111 and the slave partition 112, exist in the first HDD 110. An additional boot is not required.

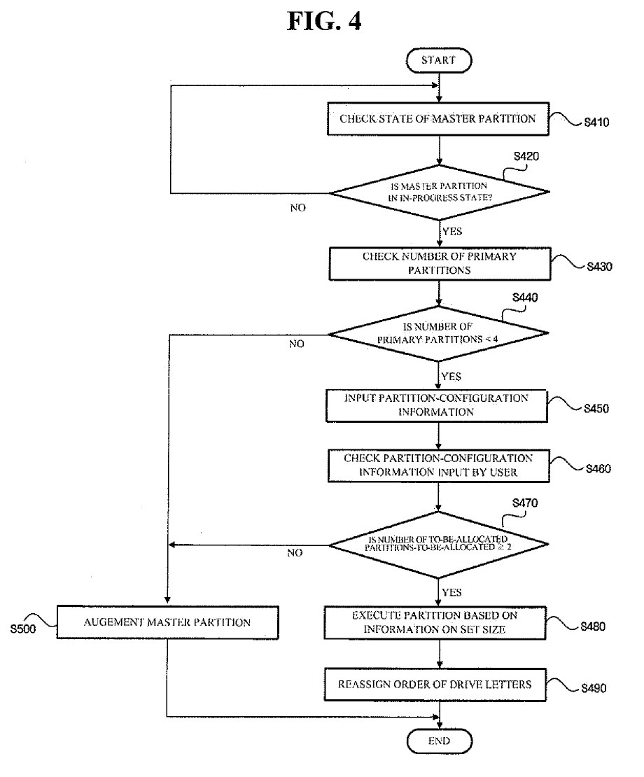

FIG. 4 is a flow chart illustrating an apparatus for partitioning a HOD without requiring a reboot according to an embodiment of the present invention. At the start, the partitioner 100 is in a state where user information has been registered through an input unit 210 and the master partition 111 has been booted.

The state-check unit 220 checks the state of the master partition 111 (S410). The state of the master partition 111 is divided into a stand-by state in which the master partition 111 has not been booted yet and an in-progress state in which user registration has been completed since an initial boot.

If the master partition 111 is in the in-progress state (S420), the hidden-partition-checking unit 240 checks the number of hidden partitions existing in the master partition 111 of the first HDD 110 S430. The OS may have a maximum number of partitions (e.g., four) and each hidden partition may be recognized as a primary partition. Accordingly, the checking of the hidden partitions is performed in order to determine whether a slave partition 112 can be divided. If the result of the checking shows that the number of a primary partition is less than four (S440), partition-configuration information is input by the user.

When the user requests the execution of a partition through a partition-configuration screen 300 (S450), the input unit 210 transmits the partition-configuration information input by the user to the controller 260. The partition-execution unit 250 checks the partition-configuration information input by the user (S460). If the result of the checking of the partition-configuration information shows that the number of to-be-allocated partitions input by the user is two or more (S470), the partition-execution unit 250 divides the slave partition 112 into the number of the partitions configured by the user (S480). Otherwise, the master partition 111 is augmented (S500).

The partition-execution unit 250 reassigns the drive letters order after the completion of the partition S490. The storage-medium-checking unit 230 checks the number of storage media (e.g., a second HDD, a CD-ROM, or other removable storage media) and gives the information thereof to the partition-execution unit 250 prior to the reassignment of the drive letters order. The partition-execution unit then repetitively reassigns the order based on information on the check storage media as follows: the HDD (e.g. the slave partition of the first HDD, and the second HDD), the CD-ROM, and other removable storage media. The controller 260 formats the newly divided partitions in the form of a random file.

Conversely, if the number of to-be-allocated partitions is less than two (S470), the partition-execution 250 combines the slave partition 112 with the master partition 111 to make the overall number of partition one, thereby augmenting the master partition 111 (S500).

If the result of the checking shows that the number of a primary partition is greater than three (S440), the slave partition cannot be divided. Accordingly, the partition-execution 250 combines the slave partition 112 with the master partition 111 to make the overall number of partition one, thereby augmenting the master partition 111 (S500).

if the master partition 111 is in the stand-by state (S420), the state-check unit 220 checks the state of the master partition 111 at a predetermined time interval (S410).

Accordingly, the user can partition the HDD into a desired number of partitions in a desired size when booting the partitioner 100 after the completion of user registration without requiring a reboot.

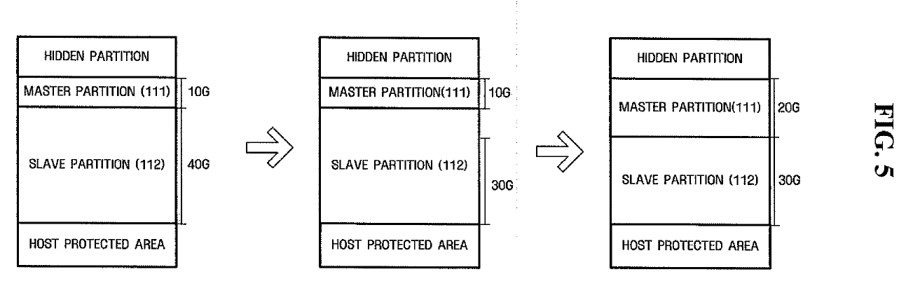

FIG. 5 illustrates a process of partitioning a HDD in an apparatus for partitioning the HDD according to an embodiment of the present invention. The overall size of an accessible partition and that of a master partition 111 are set to 50 GB and 10 GB, respectively.

First, the user inputs the number of partitions to be created and the size thereof through a partition-configuration screen 300 when dividing the accessible partition into two. When the user sets the size of the partition-to-be-created to 30 Gb, the partition-execution unit 250 computes the available space (e.g. 10 Gb) by subtracting the size set by the user (e.g. 30 G) from the size of a slave partition 112 (e.g. 40 Gb). The user then combines the calculated size (e.g. 10 Gb) with the master partition 111. Accordingly, the master partition increases to 20 Gb and the newly allocated partition is 30 Gb. Excluding the master partition 111, the order of drive letters may be reassigned as follows: the HDD (e.g., the slave partition of a first HDD and a second HDD), a CD-ROM, and other removable storage media. The new partitions may be formatted in the form of a random file. Accordingly, the user can partition the HDD into a desired number in a desired size when booting the partitioner 100 according to partition-configuration information without requiring a reboot.

As described above, according to an apparatus and method for partitioning a HDD without requiring a reboot, the following effects can be anticipated. First, the present invention is advantageous in that when a user boots a partitioner, a HDD can be divided into a desired number of partitions of a desired size without requiring a reboot after the completion of user registration. Second, the present invention is also advantageous in that the time required for the partitioning process can be reduced because the partition has been enlarged or a first HDD has an additional space arranged for a new partition. Third, the present invention is advantageous in that drive letters are reassigned to HDD, CD-ROM, and removable disk, respectively, after the completion of the partition for user convenience.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to partition a HDD comprising:
an input unit to receive user registration and partition configuration information;
a state-check unit to check a state of a master partition;
a hidden-partition-checking unit to check the number of hidden partitions in order to determine whether partitioning is achievable if the state-check unit determines that the master partition is in an in-progress state; and
a partition-execution unit to partition a slave partition based on the input partition-configuration information if the hidden partition checking unit determines that partition is achievable.

2. The apparatus of claim 1, wherein the master partition is a minimal size and the slave partition has not been allocated.

3. The apparatus of claim 2, wherein the master partition is augmented according to a size of the divided slave partition.

4. The apparatus of claim 1, wherein the partition-execution unit reassigns a drive letter order once the partition has been completed.

5. The apparatus of claim 4, further comprising a storage-medium-checking unit to check a number of storage media connected to the apparatus in order to reassign the order of the drive letters.

6. The apparatus of claim 1, wherein the partitioning of the slave partition is not completed by a reboot.

7. A method of partitioning a HDD comprising:
checking a state of a master partition;
checking the number of hidden partitions in order to determine whether the execution of a partition is achievable if the checked state of the master partition is an in-progress state;
partitioning a slave partition based on the input partition-configuration information if the checked number of hidden partitions shows that execution of the partition is achievable; and
formatting the partition after partitioning is complete.

8. The method of claim 7, wherein the master partition is a minimal size and the slave partition has not been allocated.

9. The method of claim 8, wherein the master partition can be augmented according to a size of the divided slave partition.

10. The method of claim 7, further comprising reassigning an order of drive letters after the completion of the partition.

11. The method of claim 10, further comprising checking the number of storage media in order to reassign the order of the drive letters.

12. The method of claim 7, wherein the completion of the partition does not require a reboot.

13. A computer readable medium having instructions which, when executed by a computer, perform a method comprising:
dividing a hard drive into an accessible partition and an inaccessible partition;
dividing the accessible partition into a master partition and a slave partition; and
partitioning and/or augmenting the slave partition and the master partition if an input signal chooses to partition the accessible partition into two or more partitions.

14. The computer readable medium of claim 13, wherein no reboot is required to complete partitioning and/or augmenting.

15. The computer readable medium of claim 13, wherein the master partition is a minimal size and the slave partition has not been allocated.

16. The computer readable medium of claim 13, wherein the partitioning and/or augmenting comprises augmenting the master partition with the slave partition if the input signal chooses to partition the accessible partition into one partition.

17. The computer readable medium of claim 13, wherein the method further comprises reassigning an order of drive letters.

18. A method of partitioning a hard disk comprising:
dividing an accessible partition of a hard disk into a master partition and a slave partition;
partitioning the slave partition based on input if partitioning is possible; and
formatting the partition.

19. The method of claim 18, wherein no reboot is required after partitioning.

20. The method of claim 18, wherein the partitioning the slave partition comprises augmenting the master partition if the input indicates that only one partition is to be made.

21. The method of claim 18, wherein the slave partition is not allocated.

22. An apparatus having a hard drive, the apparatus comprising:
a dividing unit to divide an accessible portion of the hard disk into a master partition and a slave partition;
a partitioner to partition the slave partition based on input if partitioning is possible; and
a formatter to format partitions created by the partitioner.

23. The apparatus of claim 22, wherein the partitioner does not reboot the apparatus to complete partitioning.

24. The apparatus of claim 22, wherein the partitioner augments the master partition if the input indicates that only one partition is to be made.

25. The apparatus of claim 22, wherein the slave partition is not allocated.
